(19) United States
(12) Patent Application Publication
(10) Pub. No.: US 2020/0341928 A1
(43) Pub. Date: Oct. 29, 2020

(54) INFORMATION PROCESSING SYSTEM

(71) Applicant: FUJITSU CLIENT COMPUTING LIMITED, Kanagawa (JP)

(72) Inventors: Yuji Nakayama, Kawasaki (JP); Masatoshi Kimura, Kawasaki (JP)

(73) Assignee: FUJITSU CLIENT COMPUTING LIMITED, Kanagawa (JP)

(21) Appl. No.: 16/810,074

(22) Filed: Mar. 5, 2020

(30) Foreign Application Priority Data
Apr. 26, 2019 (JP) 2019-086612

(51) Int. Cl. G06F 13/40; G06F 13/42

(52) U.S. Cl. CPC G06F 13/4027; G06F 13/4221

(57) ABSTRACT

In an information processing system, a first relay device includes first address ranges corresponding to first connection units of the first relay device connected to first information processing devices, and second address ranges corresponding to second connection units of a second relay device connected to second information processing devices, and transfers data for which a second address range is designated, from the first relay device to the second relay device. The second relay device includes third address ranges corresponding to the second connection units and fourth address ranges corresponding to the first connection units. When transferring data for which a second address range is designated, from the first relay device to the second relay device, the first relay device converts address information relating to the data to address information for designating a third address range and transfers the resultant address information to the second relay device.

### CROSS-REFERENCE TO RELATED APPLICATIONS

This application is based upon and claims the benefit of priority from Japanese Patent Application No. 2019-086612, filed Apr. 26, 2019, the entire contents of which are incorporated herein by reference.

### TECHNICAL FIELD

Embodiments described herein relate generally to an information processing system.

### BACKGROUND

There is known an information processing system in which a plurality of information processing devices are connected through a plurality of relay devices including a plurality of connection I/Fs (for example, expansion bus slots).

In addition, in the information processing system, the plurality of relay devices may be cascaded, and parallel distribution control in which processing is distributed to the plurality of information processing devices by a master-slave method may be performed.

However, in the related art, when expanding a distribution type computer through cascade connection, communication between a master and a slave cannot be uniformly handled, and becomes complicated.

### SUMMARY

According to an aspect of the present invention, an information processing system includes a plurality of first information processing devices, a plurality of second information processing devices, a first relay device, and a second relay device. The first relay device includes processing circuitry configured to implement a plurality of first connection units and a first relay connection unit, the plurality of first connection units connected to the plurality of first information processing devices through an expansion bus and relaying communication between the plurality of first information processing devices. The second relay device includes processing circuitry configured to implement a plurality of second connection units and a second relay connection unit, the plurality of second connection units connected to the plurality of second information processing devices through an expansion bus and relaying communication between the plurality of second information processing devices, the second relay connection unit connected to the first relay connection unit. The first relay connection unit includes a first processing unit (or first processor) that includes first address ranges each corresponding to one of the plurality of first connection units and second address ranges each corresponding to one of the plurality of second connection units in an address space, and transfers data for which a second address range is designated, from the first relay device to the second relay device. The second relay connection unit includes a second processing unit (or second processor) that includes third address ranges each corresponding to one of the plurality of second connection units and fourth address ranges each corresponding to one of the plurality of first connection units in an address space, and transfers data for which a third address range is designated, to at least any one of the plurality of second information processing devices. When transferring data for which a second address range is designated, from the first relay device to the second relay device, the first processing unit converts address information relating to the data for which the second address range is designated, to address information for designating a third address range and transfers the resultant address information to the second relay device.

### BRIEF DESCRIPTION OF THE DRAWINGS

FIG. 1 is a view illustrating an example of a whole configuration of an information processing system 1 according to an embodiment;

FIG. 2 is a block diagram illustrating a software configuration of a main unit 111 and platforms 112_1 and 112_2 according to this embodiment;

FIG. 3 is a view illustrating a corresponding relationship between the main unit 111 and platforms 112 and slot numbers on a master side, and a corresponding relationship between platforms 113 and slot numbers on a slave side in the information processing system 1 according to this embodiment;

FIG. 4 is a view illustrating an example of address ranges divided in correspondence with slot numbers in an address space which respective processing units 108, 115, and 121 on the master side can access;

FIG. 5 is a view illustrating an example of address ranges divided in correspondence with slot numbers in an address space which respective processing units 108, 115, and 131 on the slave side can access;

FIG. 6 is a view illustrating address conversion processing that is executed in a case where a processing unit 121 on the master side performs data transfer to the slave side;

FIG. 7 is a view illustrating address conversion processing that is executed in a case where a processing unit 131 on the slave side performs data transfer to the master side; and

FIG. 8 is a flowchart illustrating a flow of data transfer processing that is executed by the information processing system 1 according to this embodiment.

### DETAILED DESCRIPTION

Hereinafter, an embodiment of an information processing system will be described in detail with reference to the accompanying drawings.

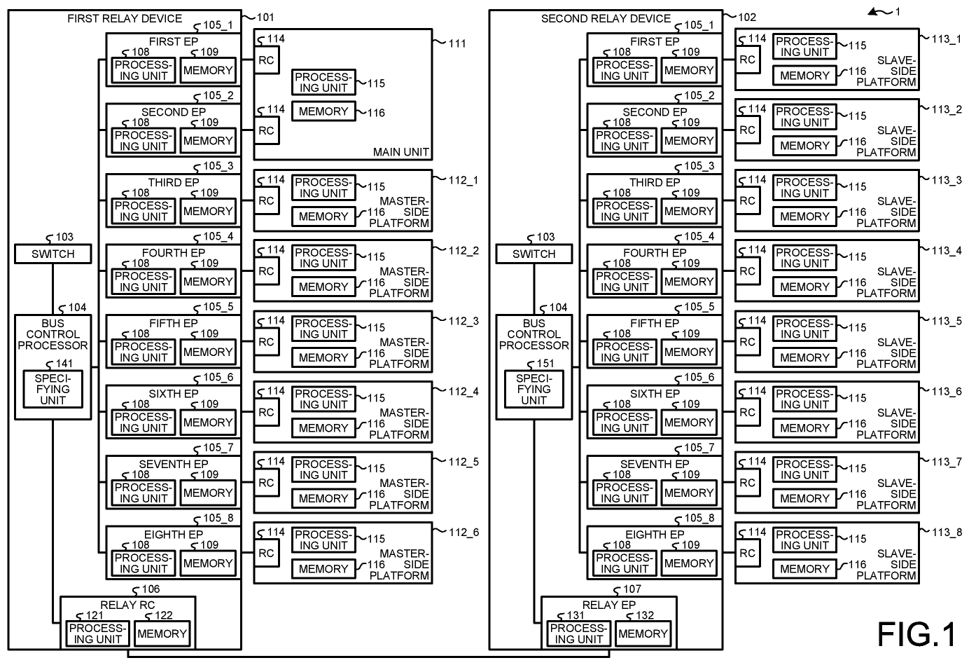

FIG. 1 is a view illustrating an example of a whole configuration of an information processing system 1 according to this embodiment. As illustrated in FIG. 1, the information processing system 1 according to this embodiment includes a first relay device 101, a second relay device 102, a main unit 111 as a main information processing device, a plurality of platforms 112-1 to 112-6 as sub-information processing devices which are connected to the first relay device 101, and a plurality of platforms 113-1 to 113-8 as sub-information processing devices which are connected to the second relay device 102.

The first relay device 101 and the second relay device 102 are connected through an expansion bus (in this embodiment, a peripheral component interconnect (PCI) express bus (hereinafter, also referred to as a PCIe bus)). In this embodiment, for the sake of specific description, a case where the first relay device 101 functions as a bus master, and the second relay device 102 functions as a slave will be exemplified. Accordingly, the plurality of platforms 112-1 to 112-6 which are connected to the first relay device 101 are referred to as master-side platforms 112-1 to 112-6, and the plurality of platforms 113-1 to 113-8 which are connected to the second relay device 102 are referred to as slave-side platforms 113-1 to 113-8.

The main unit 111 and the plurality of master-side platforms 112_1 to 112_6 are connected to the first relay device 101 through an expansion bus (for example, a PCIe bus).

In the following description, in a case where it is not necessary to distinguish the plurality of master-side platforms 112_1 to 112_6, the platforms are also collectively described as master-side platforms 112. In addition, in the information processing system 1 of this embodiment, description will be given of an example in which six platforms are provided on the master side, but a plurality of platforms (information processing devices) may be provided.

In addition, the plurality of slave-side platforms 113_1 to 113_8 are connected to the second relay device 102 through an expansion bus (for example, a PCIe bus).

In the following description, in a case where it is not necessary to distinguish the plurality of slave-side platforms 113_1 to 113_8, the platforms are also collectively described as slave-side platforms 113. In addition, in the information processing system 1 of this embodiment, description will be given of an example in which eight platforms are provided on the slave side, but a plurality of platforms (information processing devices) may be provided.

In addition, in a case where it is not necessary to distinguish the master-side platforms 112_1 to 112_6 and the slave-side platforms 113_1 to 113_8, the platforms are also collectively described as platforms 112 or 113.

### First Relay Device 101

The first relay device 101 includes a switch 103 and a bus control processor 104. In addition, the first relay device 101 includes eight end points 105 (a first end point 105_1 to an eighth end point 105_8) as a plurality of first connection units capable of being connected to the main unit 111 and the master-side platforms 112, respectively. In addition, the first relay device 101 includes a relay route complex (RC) 106 as a first relay connection unit capable of being connected to the second relay device 102.

Note that, in a case where it is not necessary to distinguish the first end point 105_1 to the eighth end point 105_8, the end points are also collectively described as end points 105.

It is assumed that the switch 103 is a hardware switch that switches the first relay device 101 to a master or a slave. In this embodiment, the switch 103 of the first relay device 101 is set to the master, and the switch 103 of the second relay device 102 is set as the slave. According to this, the first relay device 101 functions as the master, and the second relay device 102 functions as the slave.

The bus control processor 104 of the first relay device 101 controls communication with the main unit 111 and the master-side platforms 112 which are respectively connected to the end points 105. In addition, the bus control processor 104 of the first relay device 101 controls communication with the slave-side platforms 113 which are connected to the second relay device 102 through the relay route complex 106 of the expansion bus (in this embodiment, the PCIe bus). Note that, the bus control processor 104 is not limited to one processor, and may be constituted by a combination of a plurality of processors.

The bus control processor 104 includes a specifying unit 141 as a software configuration. For example, the bus control processor 104 realizes the specifying unit 141 when a central processing unit (CPU) (not illustrated) scans a program in a read only memory (ROM) (not illustrated).

The specifying unit 141 specifies a relationship between the first relay device 101 and the second relay device 102, in order words, a relationship indicating whether or not the first relay device 101 is the master or the slave with reference to setting of the switch 103. The specifying unit 141 of this embodiment specifies that the first relay device 101 is the master. In this embodiment, description will be given of an example in which the specifying unit 141 specifies the master or the slave as a relationship between the relay devices, but in a case where three or more relay devices are connected, a layer or the like may be specified without limitation to specifying of the mater or the slave. According to this, the bus control processor 104 of the first relay device 101 performs control corresponding to the relationship between the relay devices.

The first end point (EP) 105_1 to the eighth end point (EP) 105_8 of the first relay device 101 includes a processing unit 108 and a memory 109, and includes a connection I/F by an expansion bus (PCIe bus) for connection with the main unit 111 or each of the platforms 112 or 113.

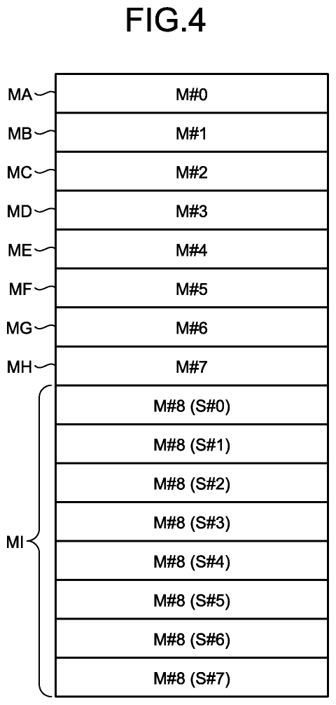

To the processing unit 108 of the end points 105 of the first relay device 101, a slot access address range for reading out or writing data from or to the main unit 111 and the platforms 112 or 113 is allocated among an accessible address space (refer to FIG. 4). The slot access address range corresponds to a total of address ranges provided in correspondence with the main unit 111 and the platforms 112 or 113. That is, the slot access address range is divided in correspondence with the main unit 111 and the platforms 112 or 113. Any one of the divided address ranges of the slot access address range is associated with any one slot. The associated slot includes a slot of the second relay device 102 in addition to a slot of the first relay device 101.

For example, an address range indicated by a slot M#0 in the slot access address range is associated with the main unit 111 connected to the slot M#0. In addition, an address range indicated by a slot M#4 in the slot access address range is associated with the platform 112_3 connected to the slot M#4. The processing unit 108 transfers transfer data to an address range allocated to a slot of a transmission destination. Note that, it is assumed that the address range of this embodiment indicates a partial range of an address space.

The processing unit 108 of the end points 105 of the first relay device 101 performs data transfer with the relay route complex 106 that is connected to the processing unit 108 through an internal bus.

That is, the processing unit 108 of the end points 105 of the first relay device 101 acquires address information indicating an address range corresponding to a slot of a transmission destination on the basis of an address range of transfer data. With regard to the acquired address information, in a case where the address is in an address range for the slave-side platforms 113, the processing unit 108 transfers data to the relay route complex 106.

The relay route complex (RC) 106 is a relay connection unit provided in the first relay device 101, includes a processing unit (or first processor) 121 and a memory 122, and includes a connection I/F for connection with a relay end point (EP) 107.

To the processing unit 121 of the relay route complex 106 of the first relay device 101, a slot access address range for reading out or writing of data is allocated in an accessible address space (refer to FIG. 4). The slot access address range corresponds to a total of address ranges provided in correspondence with the main unit 111 and the platforms 112 or 113. That is, the slot access address range is divided in correspondence with the main unit 111 and the platforms 112 or 113. Any one of the divided address ranges of the slot access address range is associated with any one slot. The associated slot includes a slot of the second relay device 102 in addition to a slot of the first relay device 101.

For example, an address range indicated by the slot M#0 in the slot access address range is associated with the main unit 111 connected to the slot M#0. In addition, an address range indicated by the slot M#4 in the slot access address range is associated with the platform 112_3 connected to the slot M#4. The processing unit 121 transfers data to an address range that is allocated to a slot of a transmission destination. Note that, details will be described later.

The processing unit 121 of the relay route complex 106 controls data transfer using an address range with the second relay device 102. That is, the processing unit 121 acquires address information indicating an address range corresponding to a slot of a transmission destination on the basis of the address range for transfer data. With regard to the acquired address information, the processing unit 121 address-converts the address information to the address range of the transmission destination, and transfers the address information after conversion and the transfer data to the relay end point 107. Note that, address conversion processing executed by the processing unit 121 of the relay route complex 106 will be described later in detail.

### Second Relay Device 102

The second relay device 102 includes the switch 103 and a bus control processor 104. In addition, the second relay device 102 includes eight end points 105 as second connection units capable of being connected to the plurality of slave-side platforms 113, respectively. In addition, the second relay device 102 includes the relay end point (EP) 107 as a second relay connection unit capable of being connected to the first relay device 101.

The bus control processor 104 of the second relay device 102 controls communication with the slave-side platforms 113 connected to the end points 105, respectively. In addition, the bus control processor 104 of the second relay device 102 controls communication with the master-side main unit 111 and the master-side platforms 112 which are connected to the first relay device 101 through the relay end point 107 of an expansion bus (in this embodiment, a PCIe bus).

The bus control processor 104 includes a specifying unit 151 as a software configuration.

The specifying unit 151 of the bus control processor 104 of the second relay device 102 specifies a relationship between the first relay device 101 and the second relay device 102, in order words, a relationship indicating whether or not the second relay device 102 is the master or the slave with reference to setting of the switch 103. The specifying unit 151 of this embodiment specifies that the second relay device 102 is the slave.

A first end point (EP) 105_1 to an eighth end point (EP) 105_8 of the second relay device 102 includes a processing unit 108 and a memory 109, and includes a connection I/F by an expansion bus (PCIe bus) for connection with each of the platforms 113.

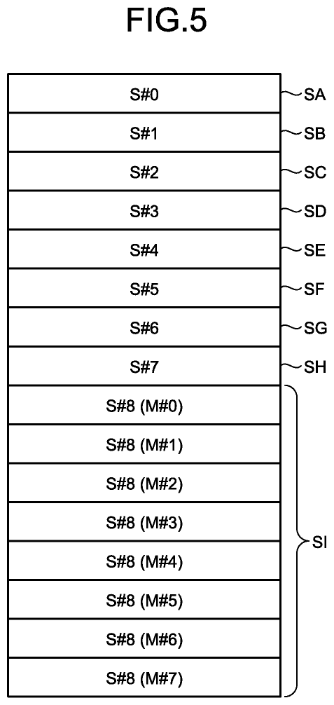

To the processing unit 108 of the end points 105 of the second relay device 102, a slot access address range for reading out or writing data from or to the main unit 111 and the platforms 112 or 113 is allocated in an accessible space (refer to FIG. 5). The slot access address range corresponds to a total of address ranges provided in correspondence with the main unit 111 and the platforms 112 or 113. That is, the slot access address range is divided in correspondence with the main unit 111 and the platforms 112 or 113. Any one of the divided address ranges of the slot access address range is associated with any one slot. The associated slot includes a slot of the first relay device 101 in addition to a slot of the second relay device 102.

For example, an address range indicated by a slot S#0 in the slot access address range is associated with the platform 113_1 connected to the slot S#0. In addition, an address range indicated by a slot S#4 in the slot access address range is associated with the platform 113_5 connected to the slot S#4. The processing unit 108 transfers transfer data to the address range allocated to a slot of a transmission destination.

The processing unit 108 of the end points 105 of the second relay device 102 performs data transfer with a route complexes 114 which are provided in the platforms 113 and are connected to the processing unit 108 through a connection I/F.

That is, the processing unit 108 of the end points 105 of the second relay device 102 acquires address information indicating an address range corresponding to a slot of a transmission destination on the basis of an address range of transfer data. The processing unit 108 address-converts the acquired address information to the address range of the transmission destination, and transfers the address information after conversion and the transfer data to the route complex 114.

The relay end point 107 includes a processing unit (or second processor) 131 and a memory 132, and includes a connection I/F for connection with the relay route complex 106.

The relay end point 107 relays communication between the plurality of slave-side platforms 113 and the plurality of master-side platforms 112 through the relay route complex 106.

To the processing unit 131 of the relay end point 107 of the second relay device 102, a slot access address range for reading out or writing of data is allocated in an accessible address space (refer to FIG. 5). The slot access address range corresponds to a total of address ranges provided in correspondence with the main unit 111 and the platforms 112 or 113. That is, the slot access address range is divided in correspondence with the main unit 111 and the platforms 112 or 113. Any one of the divided address ranges of the slot access address range is associated with any one slot. The associated slot includes a slot of the first relay device 101 in addition to a slot of the second relay device 102.

For example, an address range indicated by the slot S#0 in the slot access address range is associated with the platform 113_1 connected to the slot S#0. In addition, an address range indicated by the slot S#4 in the slot access address range is associated with the platform 113_5 connected to the slot S#4. The processing unit 131 transfers data to the address range allocated to a slot of a transmission destination. Note that, details thereof will be described later.

The processing unit 131 of the relay end point 107 of the second relay device 102 controls data transfer using an address range with the end points 105 of the second relay device 102. That is, the processing unit 131 acquires address information indicating an address range corresponding to a slot of a transmission destination on the basis of the address range of the transfer data. With regard to the acquired address information, the processing unit 131 address-converts the address information to the address range of the transmission destination, and transfers the address information after conversion and the transfer data to the end point 105 of the second relay device 102. Note that, address conversion processing executed by the processing unit 131 of the relay end point 107 will be described later in detail.

The processing unit 108 of the end points 105_1 to 105_8 of the second relay device 102 performs data transfer using an address range for reading out or writing data from or to the route complexes 114 to which the platforms 113 are respectively connected.

### Main Unit

The main unit 111 includes two route complexes (RCs) 114, a processing unit 115, and a memory 116. In addition, when the processing unit 115 executes a program stored in the memory 116, the main unit 111 functions as a host personal computer (PC) functioning as a control unit and a graphical user interface (GUI) of the information processing system 1.

It is assumed that the master-side platforms 112 and the slave-side platforms 113 are information processing devices which include a route complex (RC) 114 of an expansion bus (in this embodiment, a PCIe bus), a processing unit 115, and a memory 116, and perform various operations. In addition, when the processing unit 115 executes a program stored in the memory 116, for example, the master-side platforms 112 and the slave-side platforms 113 execute artificial intelligence (AI) inference processing, image processing, or the like.

In addition, the processing unit 115 provided in each of the main unit 111, the master-side platforms 112, and the slave-side platforms 113 may be provided from different manufacturers (vendors) or the same manufacturer.

The route complex 114 includes a connection I/F for connection with each of the end points 105.

The processing unit 115 of the main unit 111, the master-side platforms 112, and the slave-side platforms 113 controls data transfer with the end point 105 connected through the route complex 114 by using an address range.

In this embodiment, when performing communication between the main unit 111 and the platforms 112 or 113, a virtual local area network (LAN) driver is called, and data transmission/reception is performed, thereby realizing control such as communication through the virtual LAN. Here, a specific software configuration will be described.

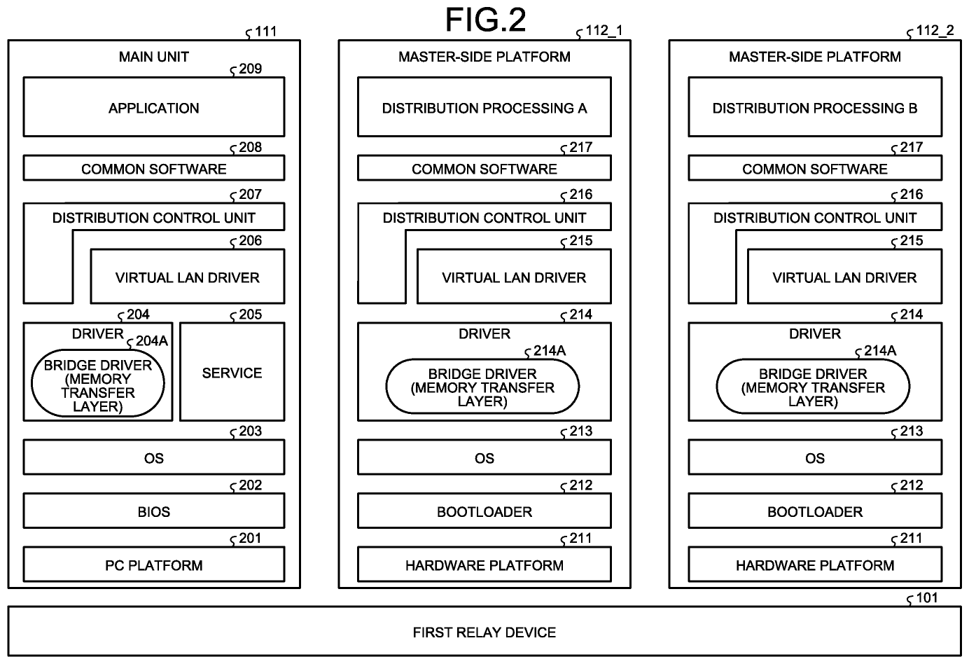

FIG. 2 is a block diagram illustrating a software configuration of the main unit and the platforms according to this embodiment.

As illustrated in FIG. 2, the processing unit 115 of the main unit 111 can execute an application 209 by realizing a basic input output system (BIOS) 202, an operating system (OS) 203, a driver 204, a service 205, a virtual LAN driver 206, a distribution control unit 207, and common software 208. It is assumed that a PC platform 201 of the main unit 111 is a hardware resource of the main unit 111.

The main unit 111 includes the BIOS 202 that performs reading of the OS 203 in activation and basic input and output control with respect to the main unit 111, and the OS 203 that is activated by the BIOS 202. For example, as the OS 203, Windows (registered trademark) is considered, but an arbitrary OS may be employed.

The OS 203 reads various kinds of the drivers 204 including a bridge driver 204A for controlling the expansion bus (for example, the PCIe bus), and accesses the route complex 114 to perform communication with other platforms (for example, the master-side platforms 112_1 to 112-6 or the slave-side platforms 113_1 to 113_8). In addition, the OS 203 reads the service 205 for performing various kinds of control to perform various kinds of processing.

In addition, on an upper layer of the driver 204 and the service 205, the virtual LAN driver 206 and the distribution control unit 207 are realized. According to this, the application 209 accesses the virtual LAN driver 206 through the common software 208 to realize communication with respect to other platforms (for example, the master-side platforms 112_1 to 112-6 or the slave-side platforms 113_1 to 113_8 through the virtual LAN.

Similarly, for example, the master-side platform 112_1 or 112_2 can execute distribution processing A or distribution processing B by realizing a Bootloader 212, an OS 213, a driver 214, a virtual LAN driver 215, a distribution control unit 216, and a common software 217. It is assumed that a hardware platform 211 is a hardware resource of the master-side platform 112_1 or 112_2.

In the master-side platform 112_1 or 112_2, the Bootloader 212 is activated when the power is turned on, and the Bootloader 212 activates the OS 213.

The OS 213 reads various kinds of the driver 214 including a bridge driver 214A for controlling the expansion bus (for example, the PCIe bus), and accesses the route complex 114 to perform communication with other platforms (for example, the main unit 111, and the master-side platforms 112_3 to 112-6 or the slave-side platforms 113_1 to 113_8).

In addition, on an upper layer of the driver 214, the virtual LAN driver 215 and the distribution control unit 216 are realized. According to this, the distribution processing A or the distribution processing B realizes communication through a virtual LAN with respect to other platforms (for example, the main unit 111, and the master-side platforms 112_3 to 112-6 or the slave-side platforms 113_1 to 113_8) by access to the virtual LAN driver 215 through the common software 217.

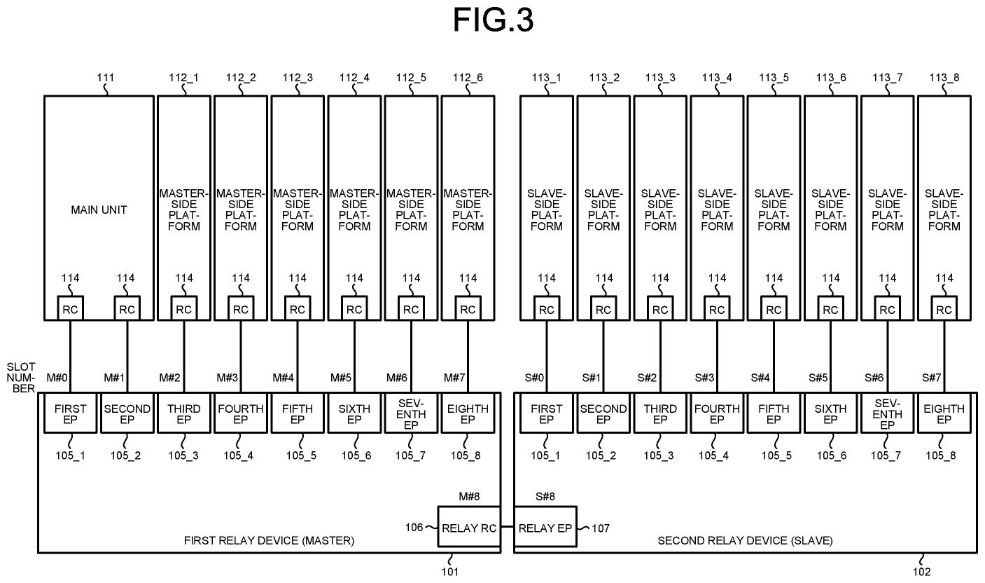

FIG. 3 is a view illustrating a corresponding relationship between the main unit 111 and the platforms 112 and slot numbers on the master side, and a corresponding relationship between the platforms 113 and the slot numbers on the slave side in the information processing system 1 according to this embodiment.

As illustrated in the same drawing, the first relay device 101 includes nine slots of a slot M#0 to a slot M#8. The main unit 111 is connected to the slots M#0 and M#1 on the master side, and the master-side platforms 112_1, 112_2, 112_3, 112_4, 112_5, and 112_6 are respectively connected to the slots M#2, M#3, M#4, M#5, M#6, and M#7 on the master side. In addition, the second relay device 102 is connected to the slot M#8 on the master side.

In addition, the second relay device 102 includes nine slots of a slot S#0 to a slot S#8. The slave-side platforms 113_1, 113_2, 113_3, 113_4, 113_5, 113_6, 113_7, and 113_8 are respectively connected to the slots S#0, S#1, S#2, S#3, S#4, S#5, S#6, and S#7 on the slave side. In addition, the first relay device 101 is connected to the slot S#8 on the slave side.

FIG. 4 is a view illustrating an example of an address range that is divided in correspondence with the slot numbers in an address space which the processing unit 115 of the main unit 111 on the master side, the processing unit 115 of the platforms 112 on the master side, the processing unit 108 of the end points 105 on the master side, and the processing unit 121 of the relay route complex 106 can access.

As illustrated in the same drawing, the address space which the processing unit 115 of the main unit 111 on the master side, the processing unit 115 of the platforms 112 on the master side, the processing unit 108 of the end points 105 on the master side, and the processing unit 121 of the relay route complex 106 can access includes address ranges MA, MB, MC, MD, ME, MF, MG, MH, and MI which respectively correspond to the slots M#0, M#1, M#2, M#3, M#4, M#5, M#6, M#7, and M#8 on the master side.

Among these, the address ranges MA, MB, MC, MD, ME, MF, MG, and MH are set as address ranges for performing local communication between master sides.

On the other hand, the address range MI corresponding to the slot M#8 is set as an address range in order for the main unit 111 or the platforms 112 on the master side to perform remote communication with the platforms 113 connected to the slave-side slots S#0, S#1, S#2, S#3, S#4, S#5, S#6, and S#7 through the second relay device 102 that is cascaded to the first relay device 101.

Accordingly, for example, data for which the address range MF (M#5) of the address space of the first end point 105_1 is designated to transfer the data from the main unit 111 to the master-side platform 112_3 is transferred (mapped) to the address range MF (M#5) of the address space of the first end point 105_5, and is finally transferred (mapped) to the address range MF (M#5) of the address space of the platform 112_3.

In addition, for example, data for which the address range MI (M#8(S#2)) of the address space of the main unit 111 is designated to transfer the data from the main unit 111 to the slave-side platform 113_3 is transferred (mapped) to the address range MI (M#8(S#2)) of the address space of the master-side first end point 105_1, and is transferred (mapped) to the slave side through the first relay device 101 and the second relay device 102 cascaded to the first relay device 101. The address conversion processing is performed in transfer to the slave side.

FIG. 5 is a view illustrating an example of an address range divided in correspondence with slot numbers in an address space which the processing unit 115 of the platforms 113 on the slave side, the processing unit 108 of the end points 105 on the slave side, and the processing unit 131 of the relay end point 107 can access.

As illustrated in the same drawing, the address space which the processing unit 115 of the platforms 113 on the slave side, the processing unit 108 of the end points 105 on the slave side, and the processing unit 131 of the relay end point 107 can access includes address ranges SA, SB, SC, SD, SE, SF, SG, SH, and SI which respectively correspond to the slots S#0, S#1, S#2, S#3, S#4, S#5, S#6, S#7, and S#8 on the slave side.

Among these, the address ranges SA, SB, SC, SD, SE, SF, SG, and SH are set as address ranges for performing local communication between slave sides.

On the other hand, the address range SI corresponding to the slot S#8 is set as an address range in order for the slave-side platforms 113 to perform remote communication with the main unit 111 and the platforms 112 which are connected to the master-side slots M#0, M#1, M#2, M#3, M#4, M#5, M#6, and M#7 through the second relay device 102 and the first relay device 101 cascaded to the second relay device 102.

Accordingly, for example, data for which the address range SD (S#3) of the address space of the first end point 105_1 on the slave side is designated to transfer the data from the slave-side platform 113_1 to the slave-side platform 113_3 is transferred to the address range SD (S#3) of the address space of the first end point 105_3, and is finally transferred (mapped) to the address range SD (corresponding to S#3) of the address space of the processing unit 115 of the platform 113_3.

In addition, for example, data for which the address range SI (S#8(M#0)) of the address space of the processing unit 115 of the slave-side platform 113_1 is designated to transfer the data from the slave-side platform 113_1 to the master-side main unit 111 is transferred (mapped) to the address range SI (S#8(M#0)) of the address space of the processing unit 115 of the first end point 105_1 on the slave side, and is transferred (mapped) to the master side through the first relay device 101 and the second relay device 102 which are cascaded. Address conversion processing is performed in transfer to the master side. Next, the address conversion processing will be described.

### Address Conversion Process

In the information processing system 1 according to this embodiment, in data transfer between the first relay device 101 and the second relay device 102, the address conversion processing is performed for handling remote communication through the first relay device 101 and the second relay device 102 which are cascaded (that is, data transfer from the master side to the slave side or data transfer from the slave side to the master side) as in local communication.

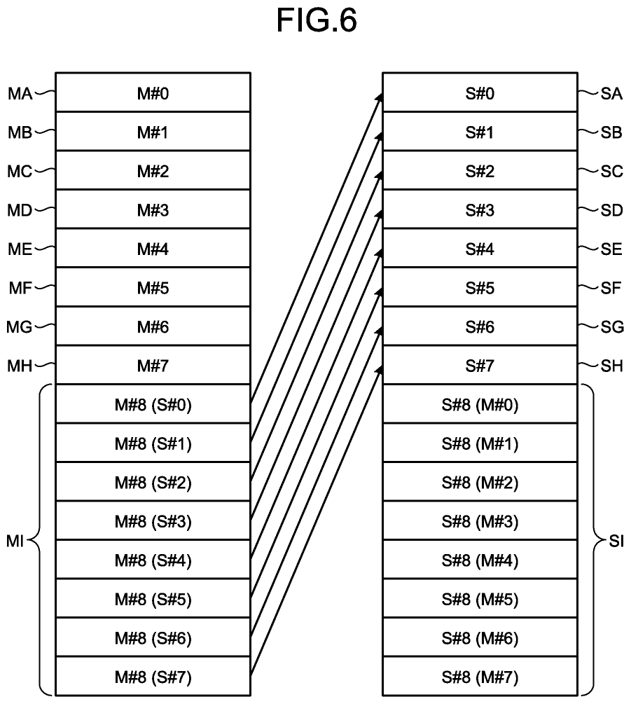

FIG. 6 is a view illustrating the address conversion processing that is executed by the processing unit 121 of the relay route complex 106 in a case where the master-side main unit 111 performs data transfer with respect to the slave-side platform 113_1 through the route complex 114 and the first EP 105_1.

As illustrated in the same drawing, the processing unit 121 of the relay route complex 106 rewrites address information of respective pieces of data so that the respective pieces of data for which M#8(S#0), M#8(S#1), M#8(S#2), M#8(S#3), M#8(S#4), M#8(S#5), M#8(S#6), and M#8(S#7) of the address range MI of the address space which the processing unit 121 of the relay route complex 106 can access is designated are mapped in the address ranges SA, SB, SC, SD, SE, SF, SG, and SH in the address space which the processing unit 131 of the relay end point 107 of a transmission destination can access.

When the address conversion is executed, for example, the driver 204 of the main unit 111 can perform data transfer to the slave-side platforms 113 through the second relay device 102 cascaded to the first relay device 101 by the same method as in data transfer control with respect to the first relay device 101. That is, special processing by software is not necessary.

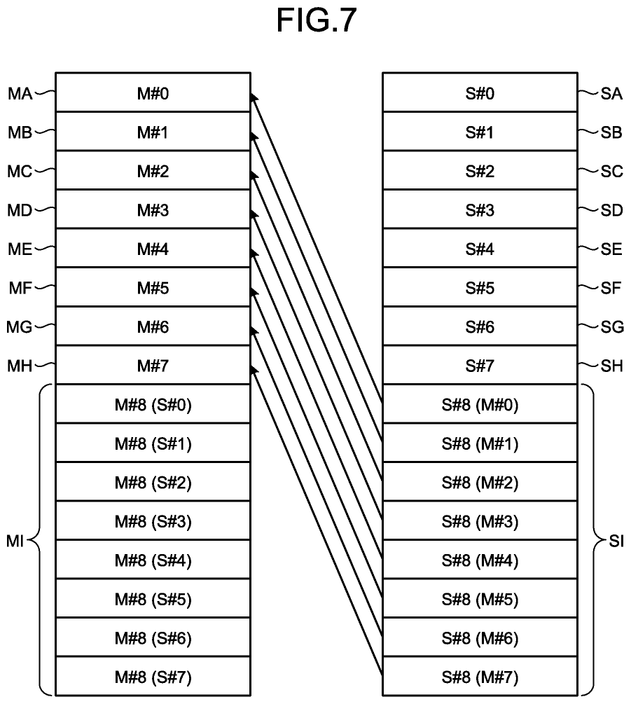

FIG. 7 is a view illustrating the address conversion processing that is executed by the processing unit 131 of the relay route complex 107 in a case where the slave-side platform 113_1 performs data transfer with respect to the master-side main unit 111 through the route complex 114 and the first EP 105_1.

As illustrated in the same drawing, the processing unit 131 of the relay end point 107 rewrites address information of respective pieces of data so that the respective pieces of data for which S#8(M#0), S#8(M#1), S#8(M#2), S#8(M#3), S#8(M#4), S#8(M#5), S#8(M#6), and S#8(M#7) of the address range SI of the address space which the processing unit 131 of the relay end point 107 can access is designated are mapped in the address ranges MA, MB, MC, MD, ME, MF, MG, and MH in the address space which the processing unit 121 of the relay route complex 106 of a transmission destination can access.

When the address conversion is executed, as in the example illustrated in FIG. 6, for example, the driver 204 of the platform 113_1 can perform data transfer to the master-side main unit 111 through the first relay device 101 cascaded to the second relay device 102 by the same method as in data transfer control with respect to the second relay device 102. That is, special processing by software is not necessary.

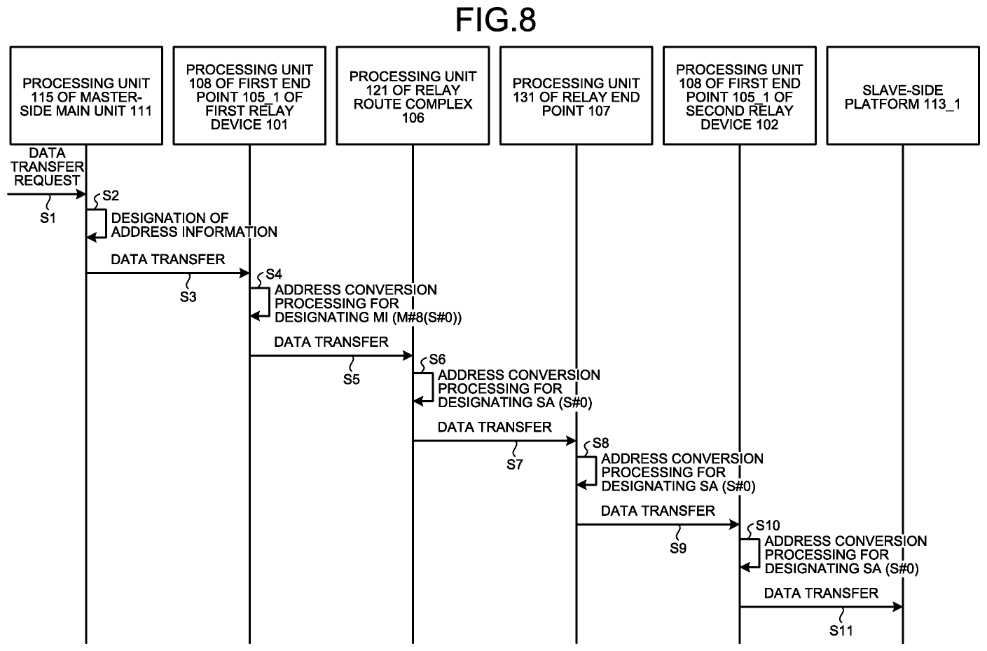

FIG. 8 is a sequence diagram illustrating a flow of processing in a case where the master-side main unit 111 performs data transfer with respect to the slave-side platform 113_1 through the first relay device 101 and the second relay device 102 in the information processing system 1 according to this embodiment.

First, the processing unit 115 of the master-side main unit 111 receives a request for data transfer to the slave-side platform 113_1 connected to the slot S#0 (Step S1).

The processing unit 115 of the master-side main unit 111 designates address information for transferring data to the address range MI (M#8(S#0)) of an address space of a transmission destination with respect to address information of transfer data (Step S2). The processing unit 115 transfers data to the first end point 105_1 on the basis of the address information (Step S3).

With respect to address information of transfer data, the processing unit 108 of the first end point 105_1 of the first relay device 101 executes address conversion processing for designating the address range MI (M#8(S#0)) of the address space which the processing unit 121 of the relay route complex 106 of a transmission destination can access (Step S4). The processing unit 108 of the first end point 105_1 transfers data to the relay route complex 106 on the basis of the address information after conversion (Step S5).

With respect to address information of transfer data, the processing unit 121 of the relay route complex 106 executes address conversion processing for designating the address range SA (S#0) of the address space which the processing unit 131 of the relay end point 107 of a transmission destination can access (Step S6). The processing unit 121 of the relay route complex 106 transfers data to the relay end point 107 on the basis of the address information after conversion (Step S7).

Through the address processing in Step S7, data of which address information is set to “address range MI (M#8(S#0))” on the master side is written to data of which address information is set to “address range SA (S#0)” on the slave side. Accordingly, transfer processing relating to the data after rewriting can be handled in the same manner as in local communication on the slave side.

With respect to address information of transfer data, the processing unit 131 of the relay end point 107 executes address conversion processing for designating the address range SA (S#0) of the address space which the processing unit 108 of the first end point 105_1 of the second relay device 102 that is a transmission destination can access (Step S8). The processing unit 131 of the relay end point 107 transfers data to the first end point 105_1 of the second relay device 102 that is a transmission destination on the basis of the address information after conversion (Step S9).

With respect to address information of transfer data, the processing unit 108 of the first end point 105_1 of the second relay device 102 executes address conversion processing for designating the address range SA (S#0) of the address space which the processing unit 115 of the slave-side platform 113_1 that is a transmission destination can access (Step S10). The processing unit 108 of the first end point 105_1 of the second relay device 102 transfers data to the slave-side platform 113_1 that is a transmission destination on the basis of the address information after conversion (Step S11).

### MODIFICATION EXAMPLE

In the above-described embodiment, for example, a case where the processing units 108, 115, 121, and 131 as a processor such as a CPU control data transfer is exemplified. However, for example, the processing units 108, 115, 121, and 131 may have a configuration in which a direct memory access (DMA) controller is provided, and data transfer is controlled by using an address conversion unit represented by the DMA controller without limitation to the above-described example. When receiving a transfer initiation instruction from a corresponding processing unit, the DMA controller executes the above-described address conversion processing and transfer processing. In this manner, when using the DMA controller, it is possible to reduce load of the processing units. In addition, when using the DMA controller, in the address space, an address range that is not limited to a base address register (BAR) space can be used in data transfer.

According to the information processing system 1 of the embodiment and the modification example, when transferring data from the master-side relay device 101 to the slave-side relay device 102 that is cascaded to the master-side relay device 101, address information for transfer to the slave side associated with the data on the master side is address-converted to local address information on the slave side. According to this, even between information processing devices 111, 112, and 113 through a plurality of (two in this embodiment) the relay devices 101 and 102 which are cascaded, the processing units 108, 115, and 121 on the master side can transfer data to the processing units 108, 115, and 131 on the slave side by the same control as in data transfer with respect to the relay device 101 on the master side (that is, the same control as in data transfer with respect to a single relay device). As a result, in the case of expanding a distribution type computer through cascade connection, it is possible to uniformly handle communication between the master and the slave.

That is, according to the information processing system 1 of the embodiment and the modification example, the relay devices 101 and 102 can uniformly process data regardless of data transmitted from the main unit 111, and the platforms 112 or 113 which are connected to a host device, and data transferred from other relay devices 101 and 102. According to this, it is possible to further reduce processing load in comparison to a case where control is made different for each data in correspondence with a difference of a transmission source. In addition, data handling becomes easy, and thus it is possible to easily perform maintenance, and it is possible to reduce work load in mounting.

Since the address conversion processing using DMAC is executed, in the address space, it is possible to use an address range that is not limited to the BAR space for data transfer.

In the above-described embodiment, description has been given of an example in which the PCIe is set as an I/O interface of each unit, but the interface is not limited to the PCIe. For example, the interface of each unit may be a technology capable of performing data transfer between a device (a peripheral control controller) and a processor by a bus through which data is transferred. The (data transfer) bus may be a general-purpose bus capable of transferring data at a high speed at a local environment (for example, one system or one device) provided one housing or the like. The interface may be any of a parallel interface and a serial interface.

In the case of serial transfer, the I/O interface may be a configuration that can establish point-to-point connection, and can transfer data in a packet base. Furthermore, in the case of the serial transfer, the I/O interface may include a plurality of lanes. A layer structure of the I/O interface may include a transaction layer that performs generation and decoding of a packet, a data link layer that performs error detection or the like, and a physical layer that performs conversion between serial and parallel. In addition, the I/O interface may include a route complex that is an uppermost layer and includes one or a plurality of ports, an end point that is an I/O device, a switch for increasing ports, and a bridge that converts a protocol, and the like. The interface may transmit transmission data and a clock signal in a state of being multiplexed by a multiplexer. In this case, a reception side may separate the data and the clock signal by a demultiplexer.

According to an embodiment, when expanding the distribution type computer through cascade connection, it is possible to uniformly handle communication between a master and a slave.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing system comprising:
a plurality of first information processing devices;
a plurality of second information processing devices;
a first relay device; and
a second relay device, wherein
the first relay device comprises a plurality of first connection units and a first relay connection unit, the first connection units connected to the first information processing devices through an expansion bus and relaying communication between the first information processing devices,
the second relay device comprises a plurality of second connection units and a second relay connection unit, the second connection units connected to the second information processing devices through an expansion bus and relaying communication between the second information processing devices, the second relay connection unit connected to the first relay connection unit,
the first relay connection unit comprises a first processor that comprises first address ranges each corresponding to one of the first connection units and second address ranges each corresponding to one of the second connection units in an address space, and transfers data for which a second address range is designated, from the first relay device to the second relay device,
the second relay connection unit comprises a second processor that comprises third address ranges each corresponding to one of the second connection units and fourth address ranges each corresponding to one of the first connection units in an address space, and transfers data for which a third address range is designated, to at least any one of the second information processing devices, and
when transferring data for which a second address range is designated, from the first relay device to the second relay device, the first processor converts address information relating to the data for which the second address range is designated, to address information for designating the first address range and transfers the resultant address information to the second relay device.

2. The information processing system according to claim 1, wherein the first processor transfers data for which a first address range is designated, to at least any one of the first information processing devices, and
when transferring data for which a fourth address range is designated, from the second relay device to the first relay device, the second processor converts address information relating to the data for which the fourth address range is designated, to address information for designating a third address range, and transfers the resultant address information to the first relay device.

3. The information processing system according to claim 1,
wherein the first processor comprises a controller that executes conversion of the address information.
